(19) United States
(12) Patent Application Publication
(10) Pub. No.: US 2024/0008423 A1
(43) Pub. Date: Jan. 11, 2024

(54) GREENHOUSE ASSEMBLY

(71) Applicant: Jungheinrich Aktiengesellschaft, Hamburg (DE)

(72) Inventors: Volker ROLLWA, Pirmasens (DE); Markus LIEBHABER, Oberursel (DE)

(73) Assignee: Jungheinrich Aktiengesellschaft, Hamburg (DE)

(21) Appl. No.: 18/217,772

(22) Filed: Jul. 3, 2023

(30) Foreign Application Priority Data
Jul. 5, 2022 (EP) 22182941.9

(51) Int. Cl. A01G 9/24; A01G 9/02

(52) U.S. Cl. CPC A01G 9/246; A01G 9/249; A01G 9/023

(57) ABSTRACT

A greenhouse assembly and method of ventilating the greenhouse assembly. The greenhouse assembly includes a housing, an interior space arranged within the housing, several plant tiers arranged within the interior space one over the other in the direction of gravity, a lighting assembly acting upon the plant tiers, and an air supply. The air supply has at least one distribution space which, with an air-permeable membrane, adjoins the interior space.

### CROSS-REFERENCE TO RELATED APPLICATION

This application claims priority under 35 U.S.C. § 119(a) to Europe Application No. 22 18 2941.9 filed Jul. 5, 2022, the disclosure of which is expressly incorporated by reference herein in its entirety.

### BACKGROUND

### 1. Feld of the Invention

Embodiments are directed to a greenhouse assembly having a housing, an interior space arranged within the housing, several plant tiers arranged one above the other in the direction of gravity within the interior space, a lighting assembly acting upon the plant tiers, and an air supply.

Embodiments are further directed to a method for ventilating a greenhouse assembly having a housing, an interior space arranged within the housing, several plant tiers arranged one above the other in the direction of gravity within the interior space, and a lighting assembly acting upon the plant tiers.

### 2. Discussion of Background Information

In such a greenhouse assembly, plants can be cultivated in several levels one above the other, so that a relatively high harvest yield can be achieved on a relatively small base area. The plants can be arranged here on carriers. Several carriers are then arranged one above the other within the housing. Because the plants require light to grow, lighting devices are arranged between the carriers or in some other way. The housing may have, for example, a rack, the sides of which are covered with panels or other flat elements, in order to obtain a closed interior space in which a climate that is favorable for plant growth can be created and maintained.

The plants as a rule require air, and in particular the carbon dioxide contained within the air. At the same time, the air should also have a temperature and a relative humidity which corresponds to the needs of the plant. Accordingly, the greenhouse assembly has an air supply with which air can be introduced continuously or at intervals into the interior space.

A critical factor in such a greenhouse assembly is that the lighting assembly produce not only light, but also heat. Even if lighting devices which produce only a small amount of heat are used here, a certain output of heat cannot be avoided. Accordingly, the air supply must ensure a certain circulation of the air present in the interior space.

In this air circulation, however, a draft should be avoided, because plants in many cases react adversely to such a draft.

### SUMMARY

Embodiments produce favorable climatic conditions in the interior space.

In embodiments, a greenhouse assembly of the type mentioned at the outset includes an air supply having at least one distribution space which, with an air-permeable membrane, adjoins the interior space.

Although the membrane is air-permeable, it also has a certain air resistance. Air which is introduced into the distribution space can therefore not easily pass into the interior space in the form of an air jet. Instead, a relatively uniform air pressure is built up in the distribution space that is somewhat higher than the air pressure in the interior space. With the aid of the pressure difference between the air pressure in the distribution space and the air pressure in the interior space, the air located in the distribution space is pushed into the interior space through the membrane. This results in an air flow distributed over the surface of the membrane, i.e., an air flow with a very large cross-section. Thus, a great deal of air can be conveyed into the interior space without causing a draft. The air flowing through the membrane has a relatively low speed of less than 0.5 m/s. Such a flow rate of the air is still acceptable for most plants while they are growing.

Preferably, an air duct opens with a flow direction into the distribution space, which air duct has a baffle plate oriented perpendicularly to the flow direction. The air therefore cannot escape from the air duct in the form of a direct jet; instead, the air flow which is introduced through the air duct into the distribution space is decelerated by the baffle plate and distributed in many directions, so that the load on the membrane due to a directional air flow can be practically avoided. Rather, an air volume with a higher pressure is generated in the distribution space.

The air duct preferably has a diffuser in the distribution space. The diffuser is arranged such that it can distribute the air impinging on the baffle plate. The diffuser then also contributes to a uniform distribution of the air fed into the distribution space.

Preferably, the diffuser has several openings arranged in a circumferential direction of the air duct. The air fed into the distribution space through the air duct can be discharged through these openings uniformly over the circumference of the air duct in the distribution space.

In this case, it is preferred that the openings have a slot-like configuration. In this way, a relatively large passage area is available, without resulting here in any directional jets which could hit the membrane.

The membrane preferably has textile material as a main constituent. The textile material may, for example, be woven or knitted, or may be a nonwoven. With a textile material, the resistance to passage of air can be adjusted relatively precisely. The air permeability may result from the material itself. However, it is also possible to achieve the air permeability by means of perforation or to modify it by means of perforation.

Preferably, the membrane has a thickened part on two parallel edges which are in engagement with parallel channels in the housing. The membrane can then easily be replaced. The thickened part just has to be pulled out of the channels, and then a new membrane with similar thickened parts introduced into the channels. The channels can be formed, for example, on a so-called “Keder strip.” The thickened part can be designed as a Keder profile.

It is preferred here that the thickened part be arranged on a retaining element joined to the membrane. The retaining element can then be designed, for example, as a Keder belt, which is sewn or glued to the membrane.

Preferably, the housing has posts, and the channels are arranged in or on the posts. The posts may be designed, for example, as aluminum extrusion profiles in which the channels can be produced at the same time.

The distribution space preferably has several distribution space sections which are arranged next to one another on one side of the interior space. Thus, the distribution space, on one side of the interior space, is divided into several smaller volumes in which it is easier to ensure a uniform pressure distribution. The air duct then has for each distribution space section its own feed. For example, an air channel can be guided past all distribution space sections and then has a dedicated branch for each distribution space section, which branch forms the air duct for the respective distributor section.

Each distribution space section preferably has an air-impermeable outer wall outside of the air-permeable membrane. All of the air fed into the distribution space section can then escape only via the membrane, and thus go only into the interior space. This is an energy-efficient solution, because practically no supplied air is wasted.

The outer wall is preferably curved. In a relatively simple manner, a curved outer wall can be kept stable against the pressures that occur. The costs for the distribution space are thus kept to a minimum.

In this case, it is particularly preferred that the outer wall form a part of an outer cylinder surface. The cylindrical outer surface may in particular be the outer surface of a circular cylinder.

Preferably, the distribution space is a first distribution space and the air duct is a first air duct, and a second distribution space together with a second air duct is arranged on an opposite side of the interior space. The air which is fed into the interior space can then, on the side opposite the first distribution space, escape through the second distribution space and be removed through the second air duct. It is thus possible to also re-use the exiting air, for example, which is particularly favorable when the greenhouse assembly is otherwise operated in an environment with dirty air, or the exiting air can be used for control purposes.

In a preferred embodiment, it is provided that the first air duct and the second air duct be connected via a switching device to a common air conveying device. The two distribution spaces can then be used alternately in order to feed air into the interior space.

When there is a transition from the first distribution space to the second distribution space, in order to feed the air, the air flows from the first distribution space to the second distribution space. If the air feed is then performed at the second distribution space, the air flow circulates within the interior space. This results in more uniform temperature conditions for the plants in the interior space. Even when there is an air flow, a slight heating of the air that is fed cannot be avoided. This then results in the plants which are furthest away from the first distribution space being exposed to a higher temperature than the plants adjacent to the first distribution space. If the air is now fed through the first distribution space and through the second distribution space in alternation, then all plants are on average impinged at least approximately with the same temperature.

According to embodiments, a method of the type mentioned at the outset includes air being fed into a distribution space adjoining the interior space and guided through an air-permeable membrane into the interior space.

With this procedure, it is possible to carry out the necessary air exchange in the interior space without causing a sharp air flow—a so-called “draft”—which is not well tolerated by many plants. The air fed into the distribution space cannot pass directly into the interior space, because the membrane here forms a certain flow resistance. The membrane ensures that a uniform air pressure can build up in the distribution space, which pressure is slightly higher than the air pressure in the interior space. The pressure difference then ensures that the air fed into the distribution space can pass through the membrane into the interior space, distributed over a large area.

Preferably, the air is directed into the distribution space against a baffle plate. The membrane is thus protected from a directional air flow. Damage to the membrane can thus be prevented.

Preferably, the air is distributed in the distribution space by a diffuser. This is a simple measure for distributing the air quickly and uniformly in the distribution space.

Preferably, the air flow in the interior space is reversed from time to time. Even in the case of controlled air exchange in the interior space, heating of the air flowing through the interior space cannot be prevented. By changing the direction of the air flow in the interior space, it can be achieved that the plants on average are always exposed to a substantially uniform temperature at all times. The change in direction can easily be achieved by arranging a distribution space in each case on opposite sides of the interior space and supplying the distribution spaces with supply air in alternation—for example, with the aid of valves.

Embodiments are directed to a greenhouse assembly that includes a housing, an interior space arranged within the housing, several plant tiers arranged within the interior space one over the other in the direction of gravity, a lighting assembly acting upon the plant tiers, and an air supply. The air supply has at least one distribution space which, with an air-permeable membrane, adjoins the interior space.

According to embodiments, an air conduit can open with a flow direction into the distribution space and the air conduit may have a baffle plate oriented perpendicularly to the flow direction.

In accordance with embodiments, an air conduit can have a peripheral wall arranged in the distribution space that has a diffuser with several openings. The several openings of the diffuser can be configured in as slots.

In other embodiments, the membrane may include a textile material as a main component.

According to embodiments, the membrane may include a thickened part on two parallel edges for engagement with parallel channels in the housing. The thickened part can be arranged on a retaining element joined to the membrane. Further, the housing can have posts and the parallel channels may be arranged in the posts.

According to other embodiments, the at least one distribution space may include several distribution space sections, which are arranged adjacent to one another on one side of the interior space. Each of the several distribution space sections can have an air-impermeable outer wall located outside of the air-permeable membrane. Further, the air-impermeable walls may be curved and/or each of the air-impermeable walls can form a part of an outer cylinder surface.

In accordance with still other embodiments, the at least one distribution space can include a first distribution space and a second distribution space arranged on opposites sides of the interior space, and the air conduit can include a first air conduit with the first distribution space and a second air conduit with the second distribution space. The air supply can further include a common air conveying device, and the first air conduit and the second air conduit may be connected to the common air conveying device via a switching device.

In still other embodiments, the air supply can include a first air supply and a second air supply and the at least one distribution space can include a first distribution space arranged on a first side of the interior space and a second distribution space arranged on a second side of the interior space that is opposite the first side. The first air supply can be coupled to the first distribution space and a second air supply conduit may be coupled to the second distribution space, the greenhouse assembly may further include a first air supply line having a first valve, a second air supply line having a second valve, and a common air conveying device coupled to the first and second supply lines. The first supply line and the second supply line may both be coupled to the first air supply conduit and to the second air supply conduit, and the first and second valves may be positionable so that the common air conveying device supplies air via the first air supply line to one of the first air supply or the second air supply and withdraws air via the second air supply line from an other of the first or second air supply.

Embodiments are directed to a method for ventilating a greenhouse assembly having a housing, an interior space arranged within the housing, several plant tiers arranged in the interior space one over the other in the direction of gravity, and a lighting assembly acting upon the plant tiers. The method includes feeding air into a distribution space adjoining the interior space. The air is conducted through an air-permeable membrane into the interior space.

According to embodiments, the air in the distribution space may be directed against a baffle plate.

In other embodiments, the air in the distribution space can be distributed through a diffuser.

In accordance with still yet other embodiments, a direction of the air flow in the interior space can be reversed from time to time.

Other exemplary embodiments and advantages of the present invention may be ascertained by reviewing the present disclosure and the accompanying drawing.

### BRIEF DESCRIPTION OF THE DRAWINGS

The invention is described below with reference to a preferred exemplary embodiment in conjunction with the drawing. In all figures, identical and corresponding elements are provided with the same reference signs. Shown here are:

FIG. 1 schematically illustrate a partial elevation of a greenhouse assembly;

FIG. 2 shows an enlarged view of a distribution space;

FIG. 3 schematically illustrate a fastening of a membrane to the housing; and

FIGS. 4A-4C schematically illustrate air flow through the greenhouse assembly.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A greenhouse assembly 1 has a housing 2 in which several plant troughs 3 are arranged one above the other in the direction of gravity. Plants, e.g., lettuce plants, are cultivated in the plant troughs.

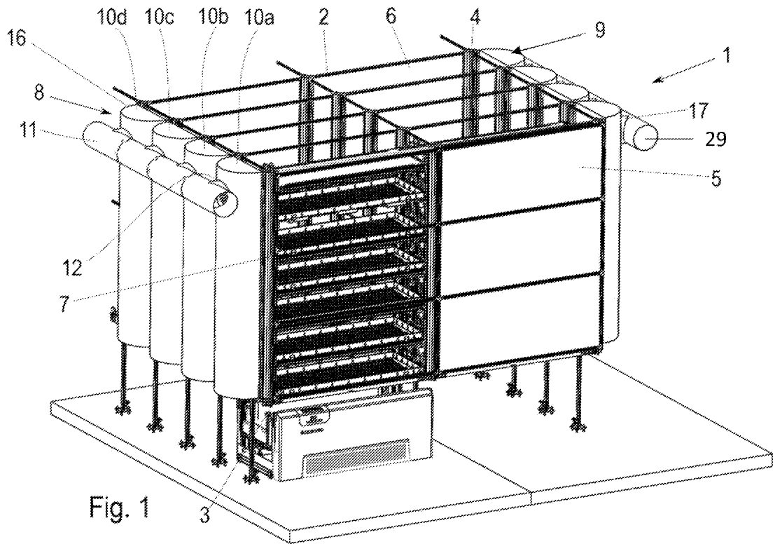

The housing 2 has multiple posts 4 which, on the one hand, carry the plant trays 3, and, on the other, may also be used for fastening wall sections 5. Such wall sections are also present in front of the plant trays 3. However, they are removed in FIG. 1 in order to be able to show the plant trays 3. The wall sections enclose an interior space 6. Arranged at the upper end of the interior space 6 in the direction of gravity, plant trays 3 without plants or correspondingly “stripped-down” carriers can be arranged, which cover the interior space. It is not necessary to seal off the interior space 6 in an airtight manner. The interior space 6 is, on its underside, largely closed off by the lowermost plant trays 3, wherein, also in this case, an air-tight closure is not required. The plant trays 3 can also be stacked directly one over the other.

The plant trays 3 and the carriers arranged at the upper end of the interior space 6 have lighting devices 7 with which each of the plants arranged under a plant tray 3 can be illuminated. A nutrient supply (not shown in more detail) is provided to feed nutrient liquid—usually water with a fertilizer—to the plant trays 3.

In addition to light, water, and nutrients, the plants also require air in order to grow. For this reason, air supply devices 8, 9 are arranged on two opposite sides of the interior space and are designed to be roughly identical in mirror-image. For this reason, only the air supply device 8 is described below in more detail. The two air supply devices 8, 9 together with an air source (not shown in more detail), e.g., a blower, form an air supply device.

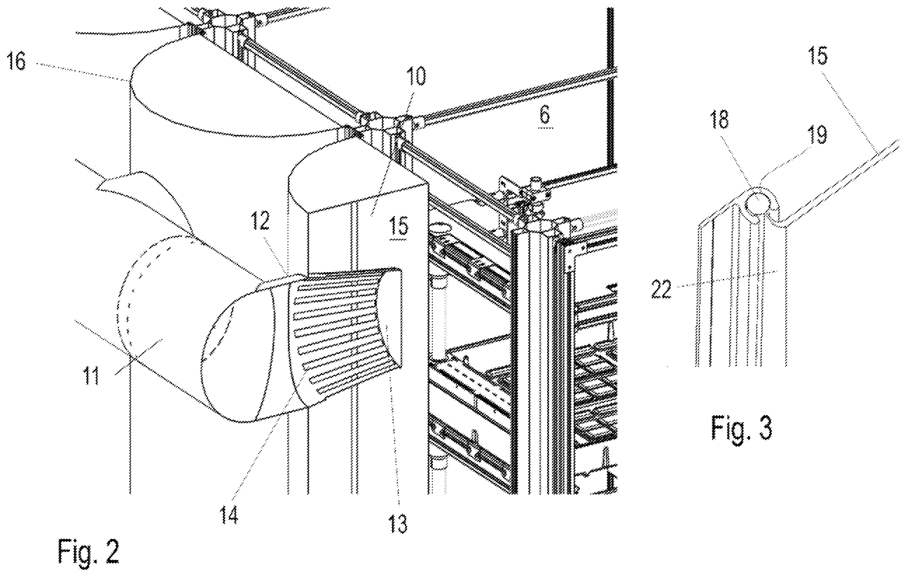

The air supply device 8 has at least one distribution space 10 (FIG. 2). The air distribution space 10 is also referred to as the first air distribution space in order to be able to differentiate it from the corresponding second air distribution spaces of the second air distribution device 9. The air distribution space 10 is divided into several distribution space sections 10a-10d, which are each closed. The air distribution spaces 10a-10d (FIG. 1) are substantially identical, so that only distribution space 10 is explained below in reference to FIG. 2.

The first air supply device 8 has an air channel 11 from which an air duct 12 branches off that goes into the distribution space 10. The air duct 12 runs substantially at a right angle to the air channel 11. However, this is not mandatory. The air duct 12 has, on its end face, which terminates in the distribution space 10, a baffle plate 13, which is oriented to be perpendicular or transverse to the flow direction through the air duct 12. In its peripheral wall in the distribution space 10, the air duct has a plurality of openings 14 arranged—preferably, evenly distributed—in the peripheral wall. The openings 14 have a slot-like configuration, i.e., they have a substantially larger length in the direction of flow than width in the circumferential direction of the air duct 12.

The distribution space 10 adjoins, with a membrane 15, the interior space 6. The membrane 15 is designed to be air-permeable. The distribution space 10 otherwise has an outer wall 16 which is impermeable to air. The outer wall 16 is curved, preferably in the form of a part of a cylindrical outer surface, and particularly preferably in the form of a part of a circular cylinder outer surface.

Although the membrane 15 is air-permeable, it poses a certain flow resistance against the air passing through. The air introduced through the air duct 12 into the distribution space 10 first hits the baffle plate 13 and then is distributed through the openings 14 around the air duct 12. The openings 14 form a diffuser. The air supplied through the air duct 12 can then be uniformly distributed in the distribution space 10 and forms an air volume having a substantially uniform pressure over the entire air volume. This pressure is slightly higher than the air pressure in the interior space 6. This pressure difference causes air from the distribution space 10 to cross into the interior space 6. This results in an air flow to the air supply device 9 on the opposite side, where the air that has flowed through the interior space can be removed again. The flow rate is relatively low here. It is less than 0.5 m/s.

The air duct 12 is arranged in the direction of gravity in the upper half, and preferably even in the upper quarter, of the distribution space 10. As a rule, the supplied air is somewhat colder than the air in the interior space 6 because the air in the interior space 6 is heated by the lighting devices 7. Accordingly, the supplied air in the distribution space 10 can also drop downwards. In contrast, if the supplied air has flowed through the interior space and reached the second air supply device 9, it can ascend there due to the increased temperature, and in turn be discharged through the second air duct 17 arranged there into second air channel 29.

FIGS. 1 and 2 show that the air channel 11 is open towards its end face. This illustration was selected in order to show the “interior” of the air channel 11 and the air duct 12. In reality, the air channel 11 here is closed in order to prevent air from escaping here.

The membrane 15 is formed from a textile material as the main component. The textile material can be woven or knitted. It can also be a nonwoven. When a textile material is used as a main component of the membrane 15, the flow resistance of the membrane 15 can be adjusted with relative precision. Where appropriate, the membrane can also be provided with small openings in the form of a perforation in order to precisely adjust the flow resistance.

To attach the membrane 15, the membrane 15 has on its two longitudinal sides a thickened part 18—for example, in the form of a Keder profile.

This thickened part 18 is inserted in a corresponding channel 19 on a post 4. It can be threaded into the profile 19 from above, for example. This results in a positive connection between the membrane 15 and a post 4. The thickened part does not have to be part of the membrane 15. The thickened part 18 can also be arranged on a retaining element 22 that is sewn or glued to the membrane.

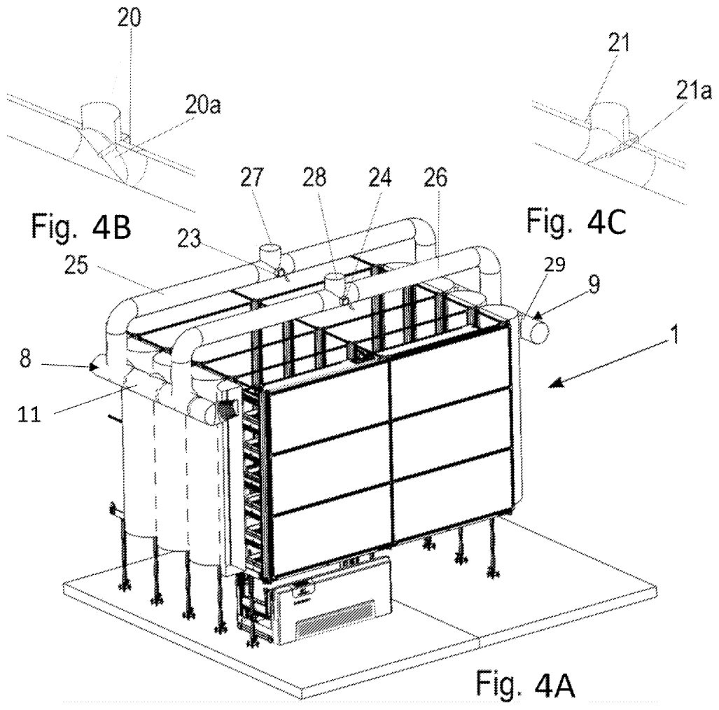

Because the two air supply devices 8, 9 are of substantially the same design, the two air supply devices 8, 9 can be used alternately for feeding air into the interior space 6. This is explained in reference to FIG. 4A.

FIG. 4A shows the view of FIG. 1, where the two air supply devices 8, 9 (or first air channel 11 and second air channel 29) are connected to one another via lines 25, 26. Line 25 in the present example has a supply air nozzle 27 which opens into line 25 via a switching valve 20 (FIG. 4B). Line 26 has an exhaust nozzle 28 which opens into line 26 via a valve 21 (FIG. 4C). The valve 20 has a flap 20a, with which supply air can be conducted via air supply nozzle 27 to either air supply device 8 or to air supply device 9. The valve 21 has a flap 21a, with which exhaust air can be conducted either from air supply device 9 or from air supply device 8 to the exhaust nozzle 28. The two valves 20, 21 each have a servomotor 23, 24, wherein the servomotors 23, 24 can be synchronized with one another.

When flap 20a is located in the position shown in FIG. 4B and flap 21a is located in the position shown in FIG. 4C, air is fed in via the first air distribution device 8, and air is removed via the second air distribution device 9. If the two flaps 20a, 21a are each located in their other position, air is fed in via second air distribution device 9, and air is removed via first air distribution device 8.

Switching between the two flow directions can take place, for example, every sixty minutes.

The air conveying device can also be provided, additionally or alternatively, with a suction device, so that the flow through the interior space can also or additionally be produced by suction.

In the air flow outside of the interior space 6, a heat exchanger can also be provided which cools the air back down if it is allowed to circulate. i.e., the heating caused by the lighting devices 7 is again removed.

With the illustrated air flow, a relatively good temperature control can be achieved.

With a flow length of, for example, 6,000 mm and an extension, along which the two air distribution devices 8, 9 are arranged, of approximately 940 mm and a height of, for example, 14,000 mm, a flow rate between the two air distribution devices 8, 9 of approximately 0.3 m/s can be achieved. In the distribution space sections, 10a-10d, there is an air pressure of approximately 300 Pa.

This results in a slightly lower temperature on the side of the inflowing air than on the side of the outflowing air. However, the temperature differences are not very large. They are essentially in the range of 0 to 5° C.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A greenhouse assembly comprising:
a housing,
an interior space arranged within the housing,
several plant tiers arranged within the interior space one over the other in the direction of gravity,
a lighting assembly acting upon the plant tiers, and
an air supply,
wherein the air supply has at least one distribution space which, with an air-permeable membrane, adjoins the interior space.

2. The greenhouse assembly according to claim 1, wherein an air conduit opens with a flow direction into the distribution space, the air conduit having a baffle plate oriented perpendicularly to the flow direction.

3. The greenhouse assembly according to claim 1, wherein an air conduit has a peripheral wall arranged in the distribution space that has a diffuser with several openings.

4. The greenhouse assembly according to claim 3, wherein the several openings of the diffuser are configured in as slots.

5. The greenhouse assembly according to claim 1, wherein the membrane comprises a textile material as a main component.

6. The greenhouse assembly according to claim 1, wherein the membrane includes a thickened part on two parallel edges for engagement with parallel channels in the housing

7. The greenhouse assembly according to claim 6, wherein the thickened part is arranged on a retaining element joined to the membrane.

8. The greenhouse assembly according to claim 6, wherein the housing has posts and the parallel channels are arranged in the posts.

9. The greenhouse assembly according to claim 1, wherein the at least one distribution space comprises several distribution space sections, which are arranged adjacent to one another on one side of the interior space.

10. The greenhouse assembly according to claim 9, wherein each of the several distribution space sections has an air-impermeable outer wall located outside of the air-permeable membrane.

11. The greenhouse assembly according to claim 10, wherein the air-impermeable walls are curved.

12. The greenhouse assembly according to claim 10, wherein each of the air-impermeable walls form a part of an outer cylinder surface.

13. The greenhouse assembly according to claim 1, wherein the at least one distribution space comprises a first distribution space and a second distribution space arranged on opposites sides of the interior space, and the air conduit comprises a first air conduit with the first distribution space and a second air conduit with the second distribution space.

14. The greenhouse assembly according to claim 13, wherein the air supply further comprises a common air conveying device, and
wherein the first air conduit and the second air conduit are connected to the common air conveying device via a switching device.

15. The greenhouse assembly according to claim 1, wherein the air supply comprises a first air supply and a second air supply and the at least one distribution space comprises a first distribution space arranged on a first side of the interior space and a second distribution space arranged on a second side of the interior space that is opposite the first side,
wherein the first air supply is coupled to the first distribution space and a second air supply conduit is coupled to the second distribution space.

16. The greenhouse assembly according to claim 15, further comprising a first air supply line having a first valve, a second air supply line having a second valve, and a common air conveying device coupled to the first and second supply lines,
wherein the first supply line and the second supply line are both coupled to the first air supply conduit and to the second air supply conduit, and
wherein the first and second valves are positionable so that the common air conveying device supplies air via the first air supply line to one of the first air supply or the second air supply and withdraws air via the second air supply line from an other of the first or second air supply.

17. A method for ventilating a greenhouse assembly having a housing, an interior space arranged within the housing, several plant tiers arranged in the interior space one over the other in the direction of gravity, and a lighting assembly acting upon the plant tiers, comprising:
feeding air into a distribution space adjoining the interior space,
wherein the air is conducted through an air-permeable membrane into the interior space.

18. The method according to claim 17, wherein the air in the distribution space is directed against a baffle plate.

19. The method according to claim 17, wherein the air in the distribution space is distributed through a diffuser.

20. The method according to claim 17, wherein a direction of the air flow in the interior space is reversed from time to time.
